(19) United States
(12) Patent Application Publication
(10) Pub. No.: US 2026/0200529 A1
(43) Pub. Date: Jul. 16, 2026

(54) SYSTEM AND METHOD FOR SPACE FRAME CHASSIS

(71) Applicant: Elemental Trucks Incorporated, Toronto (CA)

(72) Inventor: Jamie Ally, Toronto (CA)

(21) Appl. No.: 19/449,745

(22) Filed: Jan. 15, 2026

Related U.S. Application Data
(60) Provisional application No. 63/745,411, filed on Jan. 15, 2025.

(51) Int. Cl. B62D 21/02; B60L 50/71; B62D 21/18; B62D 27/02; F17C 13/08; H01M 8/04082; H01M 16/00; B62D 29/00

(52) U.S. Cl. CPC B62D 21/02; B60L 50/71; B62D 21/18; B62D 27/023; F17C 13/083; H01M 8/04201; H01M 16/006; B62D 29/007; F17C 2205/0107; F17C 2205/013; F17C 2221/012; F17C 2270/0168; F17C 2270/0184; H01M 2220/20; H01M 2250/20

(57) ABSTRACT

What is disclosed is: A space-frame chassis for a hydrogen fuel cell truck, wherein the truck comprises a cab, a front set of axles, and a rear set of axles. The space-frame chassis is coupled to the front set of axles and the rear set of axles, and supports the cab. The space-frame chassis comprises a receptacle to store a plurality of components, and a plurality of front support elements and a plurality of rear support elements mechanically coupled to the receptacle. The plurality of front support elements is coupled to a front suspension, and the plurality of rear support elements is coupled to a rear suspension.

### FIELD OF THE INVENTION

The present disclosure relates to battery and hydrogen electric trucks, and specifically to mounting of components for battery and hydrogen electric trucks.

### BRIEF SUMMARY

A space-frame chassis for a hydrogen fuel cell truck, wherein: the truck comprises: a cab, a front set of axles, and a rear set of axles; the space-frame chassis is coupled to the front set of axles and the rear set of axles, and supports the cab; and the space-frame chassis comprises: a receptacle to store a plurality of components, and a plurality of front support elements and a plurality of rear support elements mechanically coupled to the receptacle, wherein: the plurality of front support elements are coupled to a front suspension, and the plurality of rear support elements are coupled to a rear suspension.

A method for configuring storage of a hydrogen fuel-cell truck, wherein: the truck comprises a cab, and a front set of axles and a rear set of axles, wherein: a space-frame chassis is coupled to the front set of axles and the rear set of axles, and supports the cab, further wherein the space-frame chassis comprises: a receptacle, a front support element and a rear support element mechanically coupled to the receptacle, wherein: the front support element is coupled to a front suspension, and the rear support element is coupled to a rear suspension; and the method comprises one or more of: storing, using the receptacle, a plurality of components in an arrangement; or attaching a hydrogen storage frame to the receptacle.

A method of modifying a conventional chassis frame to create a first space frame chassis, wherein the conventional chassis frame comprises: a first section attached to a front suspension, a second section attached to a rear suspension, and a center section located between the first section and the second section; the method comprising: removing the center section; and inserting an adjusted space frame-chassis between the first section and the second section.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1A is an isometric view of an example embodiment of a hydrogen fuel-cell truck with a space-frame chassis.

FIG. 1B is a top view of an example embodiment of a hydrogen fuel-cell truck with a space-frame chassis.

FIG. 1C is a side view of an example embodiment of a hydrogen fuel-cell truck with a space-frame chassis.

FIG. 1D is an isometric view of another example embodiment of a hydrogen fuel-cell truck with a space-frame chassis.

FIG. 2A is an isometric view of an example embodiment of a space-frame chassis.

FIG. 2B is a side view of an example embodiment of a space-frame chassis.

FIG. 2C is a top view of an example embodiment of a space-frame chassis.

FIG. 2D is an isometric view of another example embodiment of a space-frame chassis.

FIG. 2E is a side view of another example embodiment of a space-frame chassis.

FIG. 2F is a top view of another example embodiment of a space-frame chassis.

FIG. 3A is a side view of an example embodiment where hydrogen tanks are stored in a backpack configuration within a storage frame.

FIG. 3B shows a front view of an example embodiment of a receptacle with a storage frame.

FIG. 3C shows an isometric view of an example embodiment of a receptacle with a storage frame.

FIG. 3D is a side view of another example embodiment of a storage frame.

FIG. 3E shows a front view of another example embodiment of a receptacle with a storage frame.

FIG. 3F shows an isometric view of another example embodiment of a receptacle with a storage frame.

FIG. 3G is a side view of yet another example embodiment of a storage frame.

FIG. 3H shows a top view of yet another example embodiment of a receptacle with a storage frame.

FIG. 3I shows a front view of yet another example embodiment of a receptacle with a storage frame.

FIG. 3J shows a isometric view of yet another example embodiment of a receptacle with a storage frame.

FIG. 4A shows a top view of an embodiment of a storage arrangement.

FIG. 4B shows an isometric view of an embodiment of a storage arrangement.

FIG. 4C shows a side view of an embodiment of a storage arrangement.

FIG. 4D shows another isometric view of an embodiment of a storage arrangement.

FIG. 4E shows a top view of yet another embodiment of a storage arrangement.

FIG. 4F shows an isometric view of yet another embodiment of a storage arrangement.

FIG. 4G shows a side view of yet another embodiment of a storage arrangement.

FIG. 4H shows another isometric view of yet another embodiment of a storage arrangement.

FIG. 5 shows an isometric view of another embodiment of a storage arrangement.

FIG. 6 shows an embodiment of a process flow for storing a plurality of components.

FIG. 7 shows an embodiment of a process flow for modifying a conventional or typical truck chassis frame.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

The conventional diesel truck chassis has been optimized over decades for diesel powertrains. In a conventional diesel truck chassis, two central C-channels run the length of the truck. The axles, engine, cab, and all other major components, are mounted to the C-channels. A driveshaft runs between the C-channels from the engine at the front to the drive axles at the rear.

For electric vehicles with electrified axles, there is often no central driveshaft running from the front engine compartment to the drive axles. The conventional dual C-channels present a packaging problem, resulting in components like batteries, motors, hydrogen tanks, and other components, being mounted in suboptimal locations which increase the weight, increase the cost, and reduce the performance of the vehicle.

Hydrogen electric trucks have all had hydrogen tank systems mounted atop the truck chassis rails at the rear of the cab in a “backpack” configuration, or aside the chassis rails in a “side saddle” configuration. Examples of such trucks which used such arrangements include: Hyzon Motors: see, for example https://www.hyzonfuelcell.com/vehicles/hyhd8-200kw retrieved January 10, 2025; Nikola TRE FCEV: see, for example https://www.nikolamotor.com/tre-fcev, retrieved January 10, 2025; Hyundai XCIENT fuel cell: see, for example https://ecv.hyundai.com/global/en/products/xcient-fuel-cell-truck-fcev, retrieved January 10, 2025; and- Kenworth T680 Fuel Cell EV: see, for example https://www.kenworth.com/trucks/t680-fcev/ , retrieved January 10, 2025.

This design is problematic for several reasons: The high centre of gravity increases the rolling moment, The high center of gravity of the hydrogen storage unit acts as a pendulum about the chassis rails, which often results in modal problems at typical on-road vibration frequencies, and - The attachment of the structure with the hydrogen tank systems to the relatively narrow chassis rails requires a heavy steel structure, which significantly increases the overall mass of the tractor.

Using a side-saddle configuration poses certain problems. In the side-saddle configuration, carrying capacity is limited to no more than one or two cylinders, and most trucks require four to eight cylinders. Balance is typically a problem with the side-saddle configuration.

This arrangement eliminates the need for side-saddle configurations, and is a more efficient way of integrating, without the problems due to balance.

Space-frame chassis with receptacles for holding components have been contemplated before. For example, European Patent Application 3,658,398 to Hannefort et al filed 10 September 2019, and hereinafter referred to as “Hannefort”, discloses a space-frame chassis with a receptacle. However, the receptacle is at the same height as the chassis rails, which does not resolve the issues due to centre of gravity.

A system and method for a space-frame chassis for an electric truck is described below, which addresses the shortcomings and challenges described for the prior art above. While the embodiments below are described for an electric truck having hydrogen fuel cells, one of ordinary skill in the art would understand that the space-frame chassis demonstrated below could also be used in, for example, an electric truck with batteries and no hydrogen fuel cells.

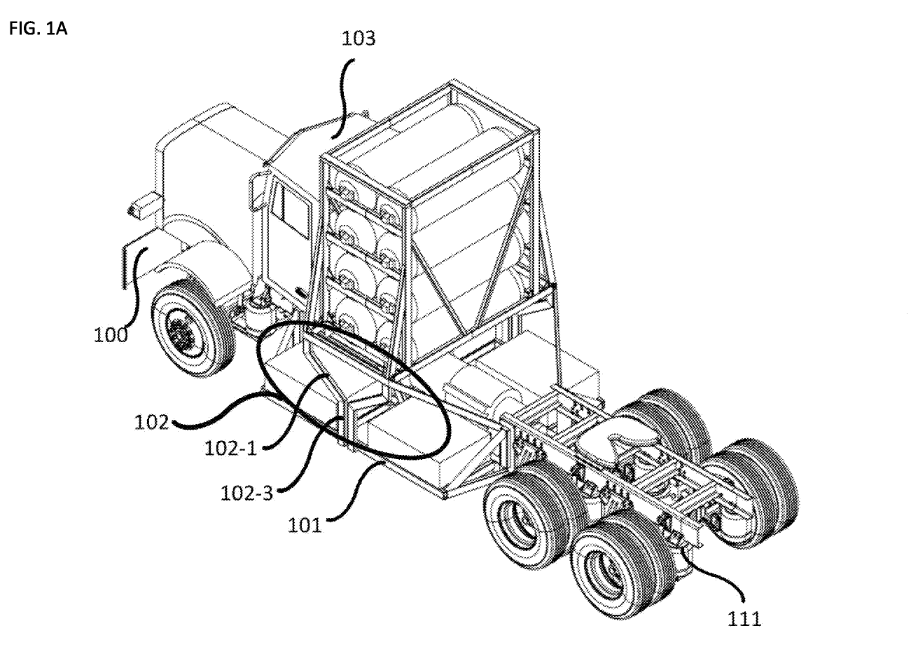

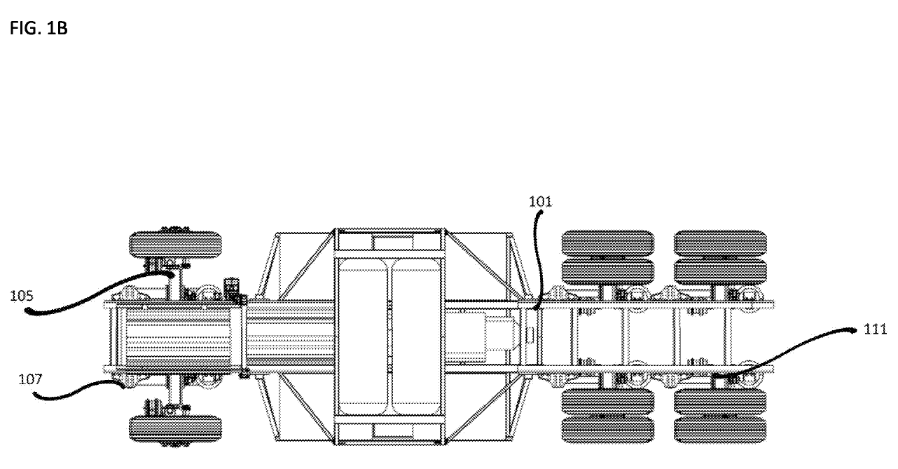

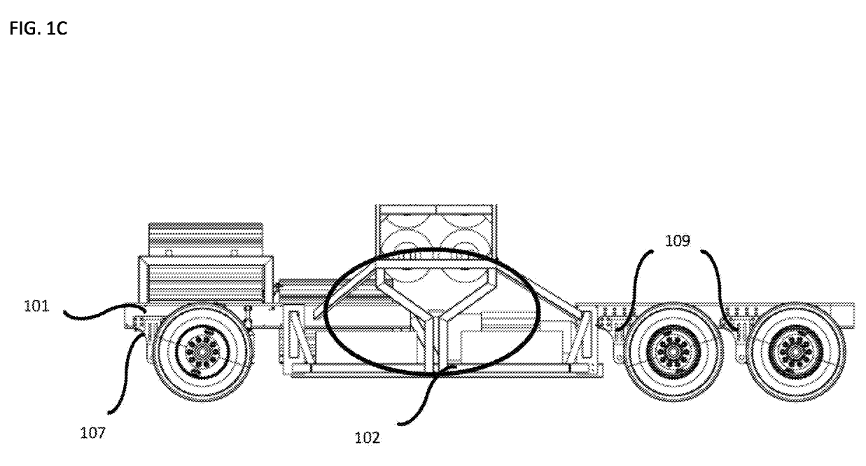

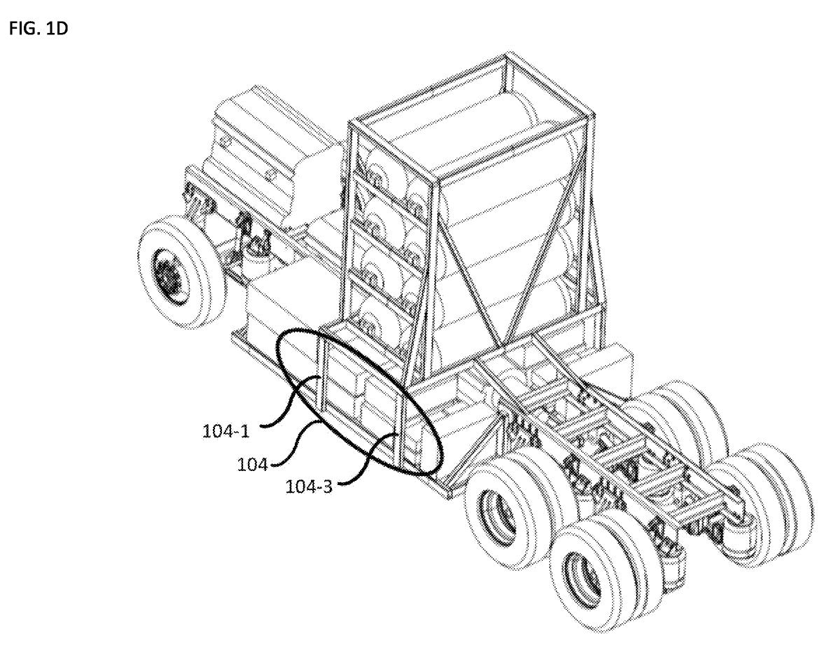

FIGS. 1A, 1B and 1C show isometric, top and side views of an example embodiment of a hydrogen fuel-cell truck 100 with space-frame chassis 101. The truck comprises cab 103, front set of axles 105, front suspension 107, rear suspension 109 and rear set of axles 111.

In some embodiments, as shown in FIGS. 1B and 1C, space-frame chassis 101 couples to the front suspension and/or front axles; and the rear suspension and/or rear axles.

The example embodiment shown in FIGS. 1A, 1B and 1C comprise an attachment structure such as attachment structure 102. As shown in FIGS. 1A and 1C, attachment structure 102 comprises diagonal portions such as diagonal portion 102-1, coupled to vertical attachment members such as vertical attachment member 102-3. In some embodiments, as is explained below, attachment structure 102 is used to attach a hydrogen storage frame.

Another example embodiment of an attachment structure is shown in FIG. 1D. Attachment structure 104 in FIG. 1D comprises vertical attachment members 104-1 and 104-3; and does not comprise the diagonal portions shown in FIGS. 1A and 1C.

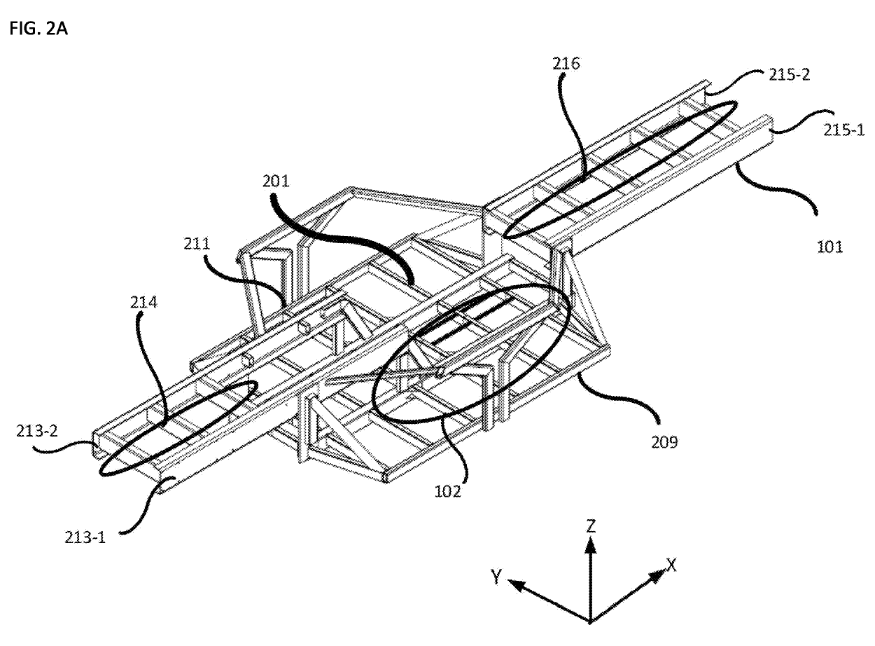

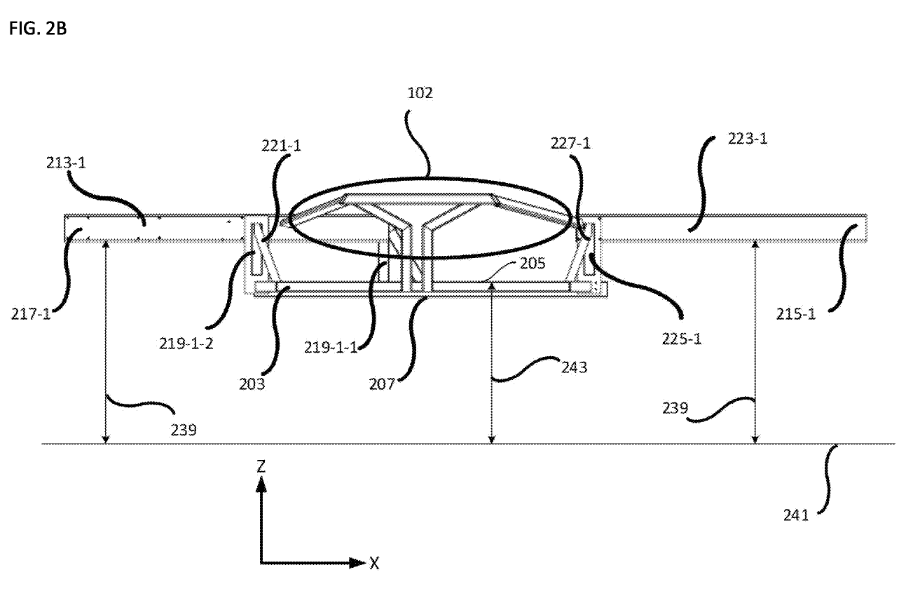

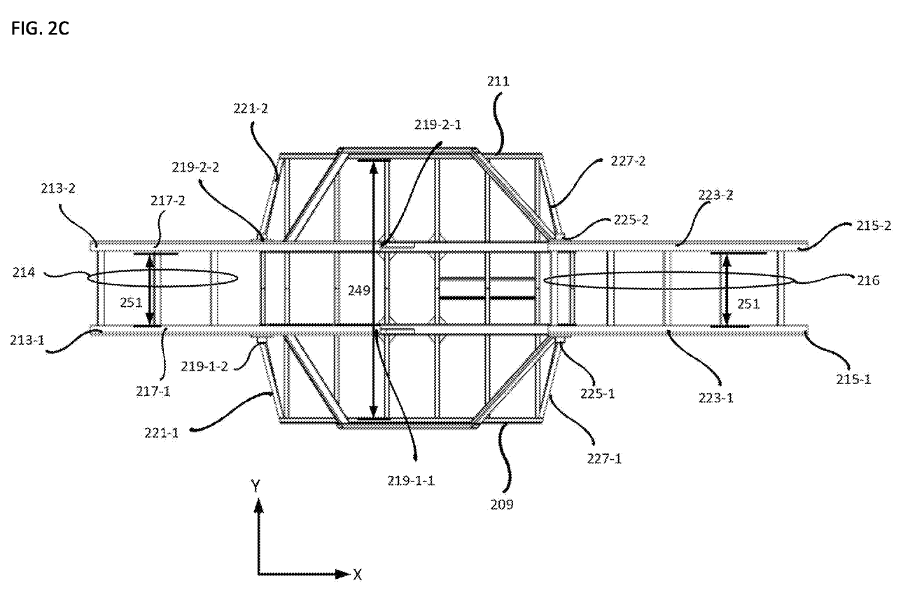

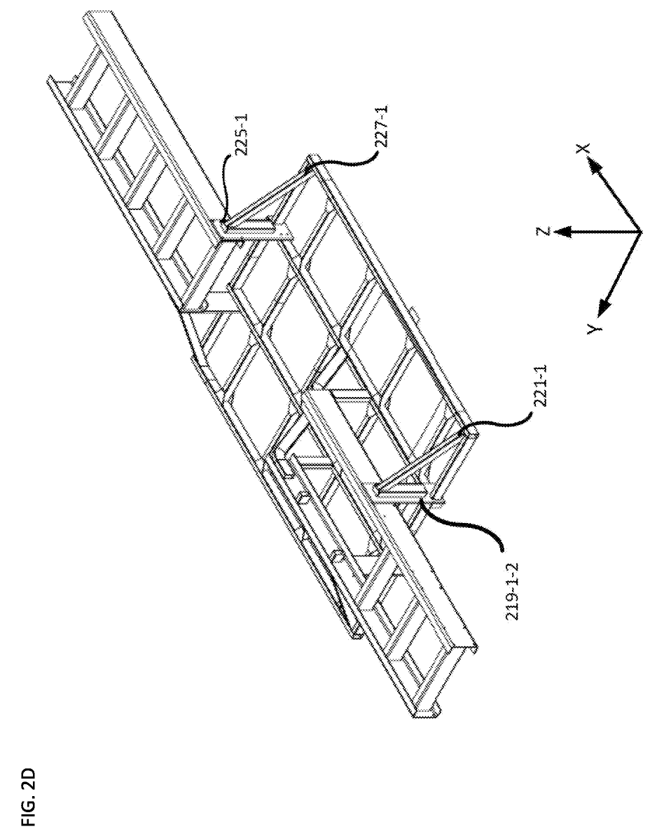

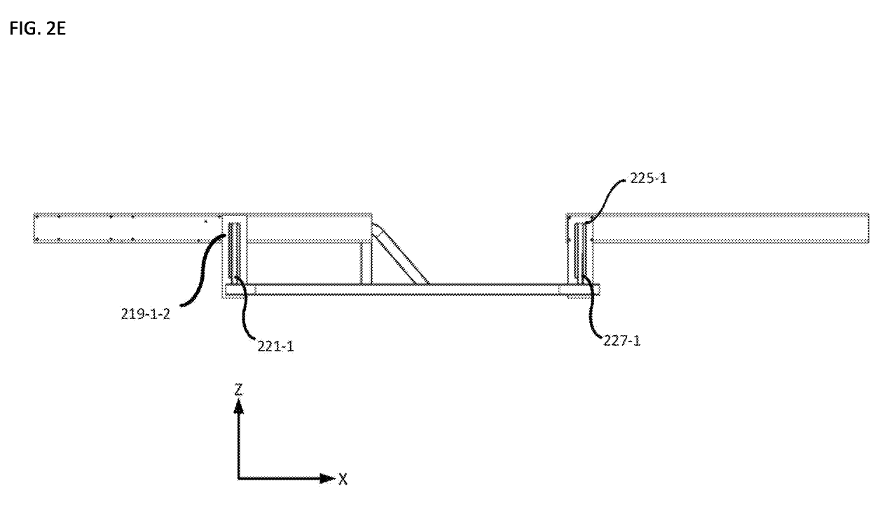

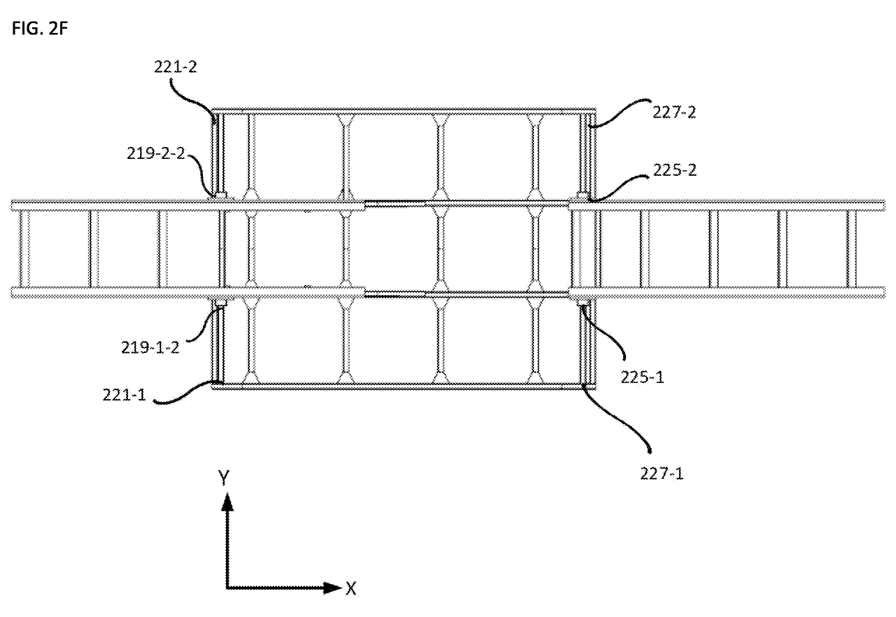

FIGS. 2A, 2B and 2C show isometric, side and top views of space frame chassis 101 respectively. In some embodiments, space-frame chassis 101 is a lightweight, truss-like structure constructed from welded metal tubing. By using welded metal tubing, this reduces the total weight of the chassis.

Referring to FIG. 2A, space-frame chassis comprises a receptacle 201. Receptacle 201 stores a plurality of components. Examples of these components comprise: A hydrogen storage module, One or more battery modules, A fuel cell modu - A drivetrain, and, - components to support e-axle truck operation such as motors and transmission, which are known to those of ordinary skill in the art.

Various arrangements for storage of the plurality of components are demonstrated further below.

As shown in FIG. 2B, receptacle 201 comprises horizontal surface 203. Horizontal surface 203 comprises top 205 and bottom 207. Then, the plurality of components is stored on the top 205 of horizontal surface 203. Referring to FIGS. 2A and 2C, sidewalls 209 and 211 act to restrain and prevent components from falling off the horizontal surface 203 due to transverse movement, which is movement perpendicular to the direction of travel of the truck.

As shown in FIGS. 2A, 2B and 2C, space-frame chassis 101 comprises front support elements 213-1 and 213-2; and rear support elements 215-1 and 215-2 mechanically coupled to the receptacle 201. As also shown in FIGS. 2A, 2B and 2C, the front support elements 213-1 and 213-2 are separated from rear support elements 215-1 and 215-2. Each of the front support elements comprise a front support horizontal portion coupled to one or more front support vertical portions. For example, referring to FIG. 2B, front support element 213-1 comprises front support horizontal portion 217-1 coupled to front support vertical portions 219-1-1 and 219-1-2. Similarly, referring to FIG. 2C, front support element 213-2 comprises front support horizontal portion 217-2 coupled to front support vertical portions 219-2-1 and 219-2-2.

The front support vertical portions are coupled to the top 205 of horizontal surface 203. For example, the front support vertical portions 219-1-1 and 219-1-2 of the front support element 213-1 are coupled to top 205 of horizontal surface 203. The front support horizontal portions 217-1 and 217-2 extend longitudinally in the forward direction and are coupled to front suspension 107.

In some embodiments, at least one of the front support vertical portions are further coupled to top 205 via front diagonal coupling elements. For example, referring to FIG. 2B, front support vertical portion 219-1-2 is coupled to top 205 via front diagonal coupling element 221-1. In some embodiments, a load-bearing structural interface designed to transfer longitudinal, vertical, and torsional loads is used to couple front diagonal coupling element 221-1 to front

support vertical portion 219-1-2. Referring to FIG. 2C, front support vertical portion 219-2-2 is coupled to top 205 via front diagonal coupling element 221-2. In some embodiments, similar to as described previously, a load-bearing structural interface is used to couple front diagonal coupling element 221-2 to front support vertical portion 219-2-2.

The front diagonal coupling elements provide further support and securing to the top 205 for the front support vertical portions; and the combination of the front diagonal coupling elements with the front support vertical elements act as a front wall or front restraint for components. That is, the combination prevents components from moving longitudinally in the forward direction and, for example, either falling off horizontal surface 205 or damaging the cab 103. In embodiments where one or more load-bearing structural interfaces are used, this further strengthens the coupling.

As shown in FIGS. 2A and 2C, one or more front transverse members 214 are attached to both front support horizontal portions 217-1 and 217-2. By attaching to both front support horizontal portions, the one or more front transverse members 214 assist in strengthening the structure, thereby enabling front support horizontal portions 217-1 and 217-2 to perform their functions better. In some embodiments, the quantity of front transverse members is based on weight requirements.

Similarly, each of the rear support elements 215-1 and 215-2 comprise a rear support horizontal portion coupled to at least one rear support vertical portion. For example, referring to FIG. 2C, rear support element 215-1 comprises rear support horizontal portion 223-1 coupled to rear support vertical portion 225-1. Rear support element 2-152 comprises rear support horizontal portion 223-2 coupled to rear support vertical portion 225-2. The rear support horizontal portions extend longitudinally in the rear direction and are coupled to rear suspension 109. As shown in FIGS. 2A and 2C, one or more rear transverse members 216 are attached to both rear support horizontal portions 223-1 and 223-2. By attaching to both rear support horizontal portions, the one or more rear transverse members 216 assist in strengthening the structure, thereby enabling rear support horizontal portions 223-1 and 223-2 to perform their functions better. In some embodiments, the quantity of rear transverse members is based on weight requirements.

The rear support vertical portions 225-1 and 225-2 are coupled to top 205 of horizontal surface 203. In some embodiments, at least one of the rear support vertical portions are coupled to top 205 via rear diagonal coupling elements. For example, with reference to FIG. 2C, rear support vertical portion 225-1 is coupled to rear diagonal coupling element 227-1; and rear support vertical portion 225-2 is coupled to rear diagonal coupling element 227-2. Similar to the front diagonal coupling elements, the rear diagonal coupling elements provide further support and securing to top 205 for the rear support vertical portions. The combination of the rear diagonal coupling elements with the rear support vertical elements act as a rear wall or rear restraint for components. That is, the combination prevents components from moving longitudinally in the rear direction and, for example, falling off the horizontal surface 203 or damaging other components of the truck. Similar to the front diagonal coupling elements, in some embodiments load-bearing structural interfaces are used to couple the rear support vertical portions to the rear diagonal coupling elements, so as to strengthen the coupling.

As shown in FIGS. 2B and 2C, the horizontal portions 217-1 and 217-2 of the front support elements 213-1 and 213-2; and horizontal portions 223-1 and 223-2 of the rear support elements 215-1 and 215-2 are at height 239 from, for example, surface 241 which is in contact with the wheels of the truck 100. Top 205 of horizontal surface 203 is at height 243 from surface 241. As shown in FIG. 2, height 243 is lower than height 239. By positioning the top 205 at a lower height, when the receptacle 201 stores components, the truck’s centre of gravity and therefore rolling moment is lowered compared to prior art systems such as Hannefort, thereby making the truck more stable.

As is shown in FIGS. 2A, 2B and 2C, front diagonal coupling elements 221-1 and 221-2 extend in the z-direction, and also in both the x- and y-directions. Similarly rear diagonal coupling elements 227-1 and 227-2 extend in the z-direction, and also in both the x- and y- directions. Axes are shown for illustrative purposes in FIGS. 2A, 2B and 2C.

In some embodiments, front diagonal coupling elements extend in the z-direction, and only in the y-direction. There is no extension in the x-direction. Example embodiments are shown in FIGS. 2D, 2E and 2F. In FIGS. 2D, 2E and 2F, front diagonal coupling elements 221-1 and 221-2 extend in the z-direction and the y-direction, with no extension in the x-direction. Axes are shown for illustrative purposes in FIGS. 2D, 2E and 2F.

In some embodiments, rear diagonal coupling elements 227-1 and 227-2 extend in the z-direction and in the y-direction. There is no extension in the x-direction. Example embodiments are shown in FIGS. 2D, 2E and 2F.

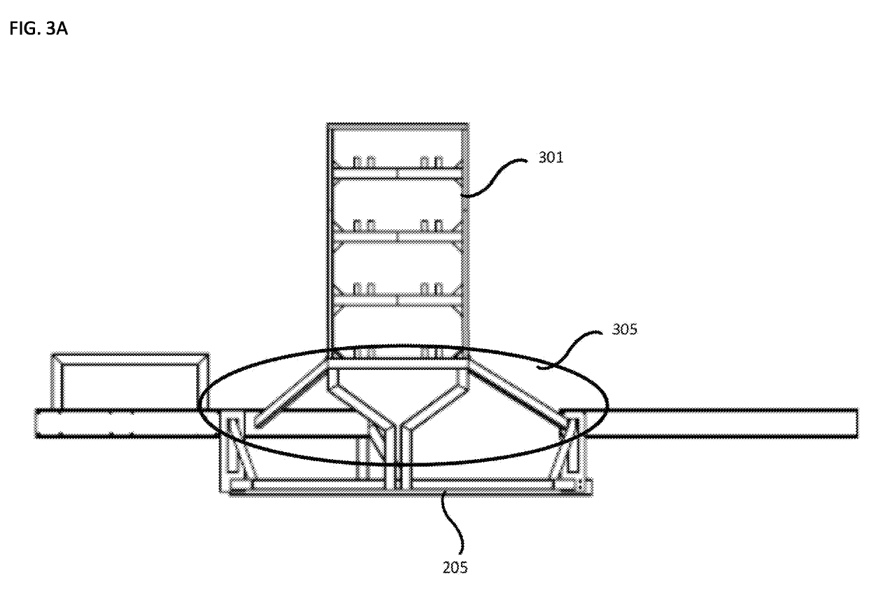

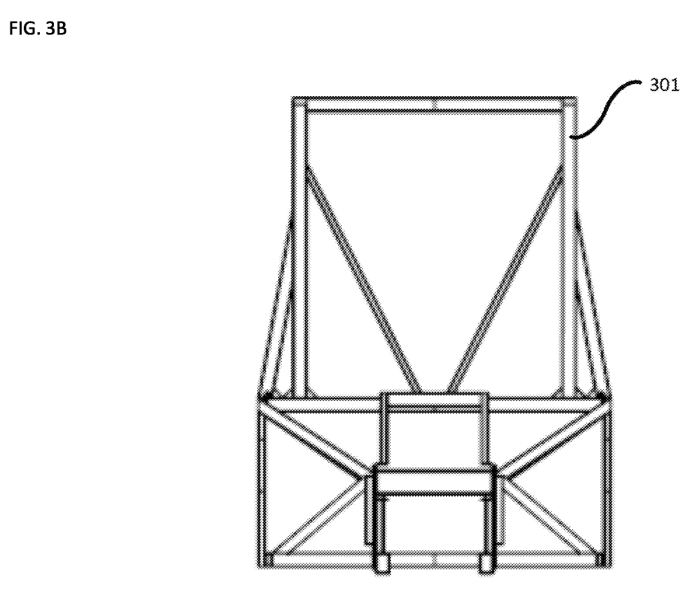

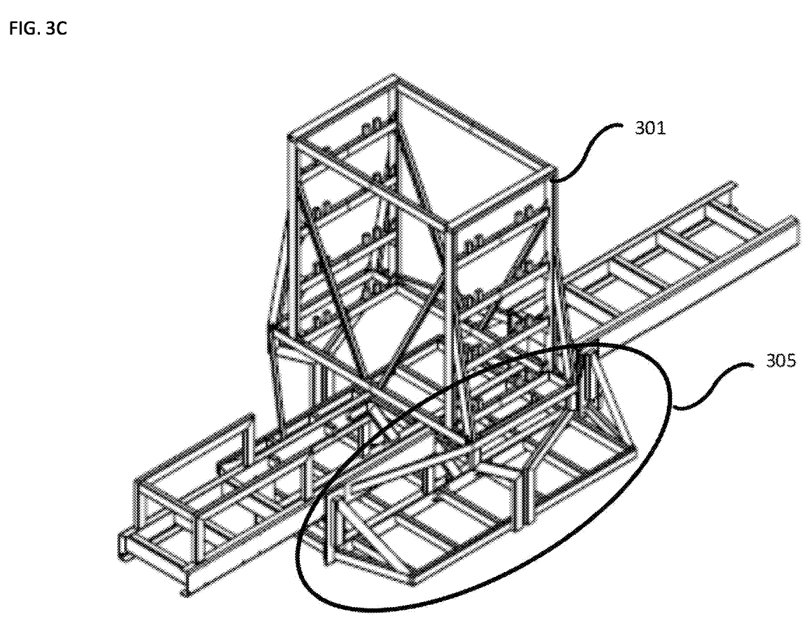

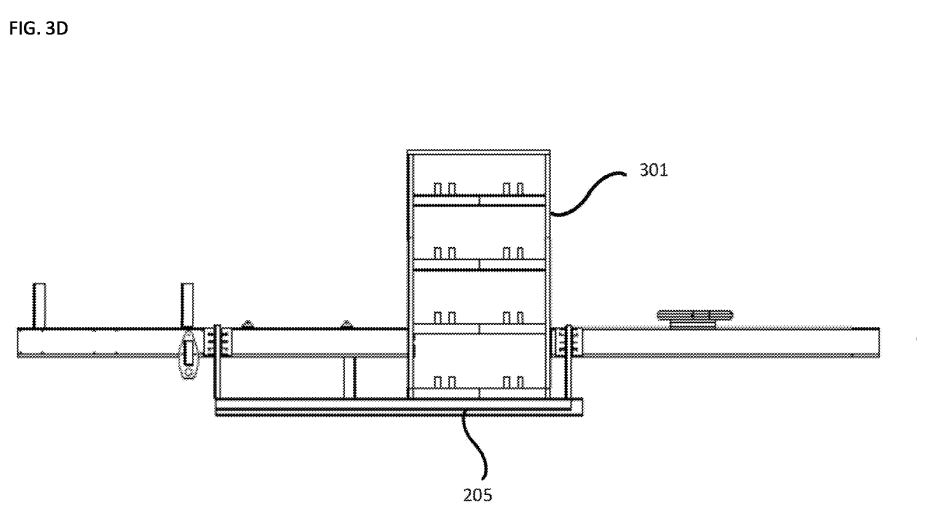

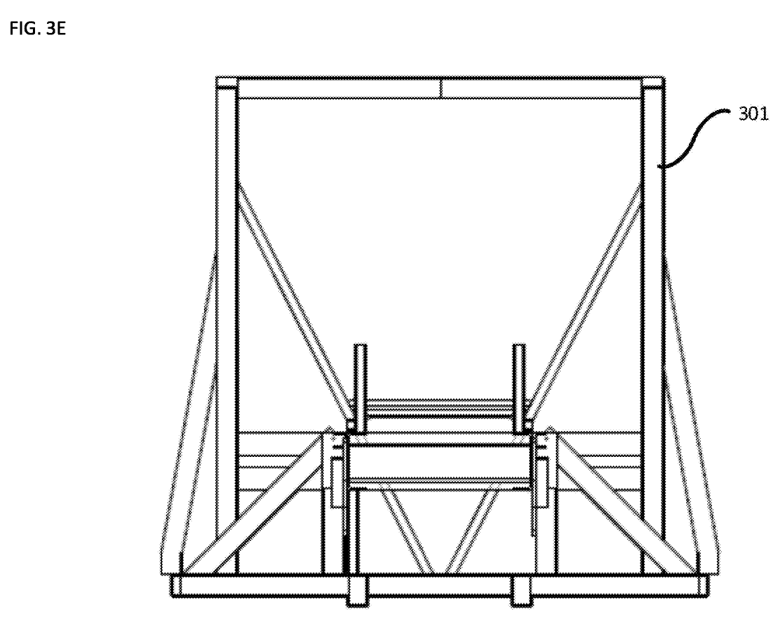

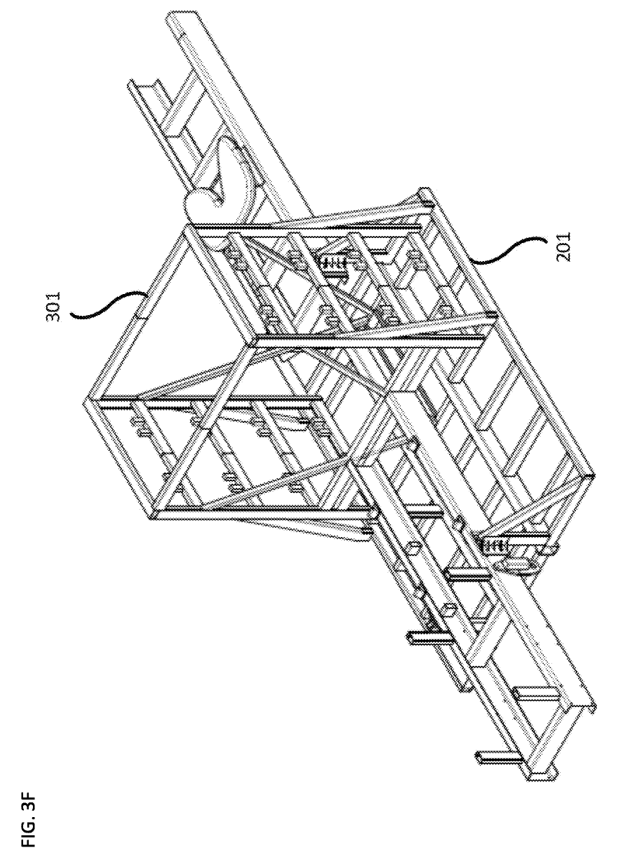

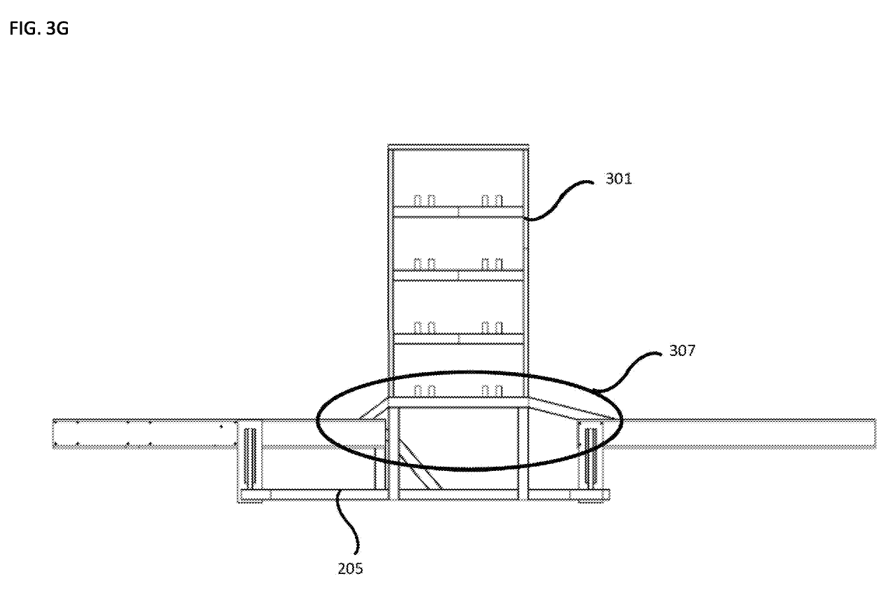

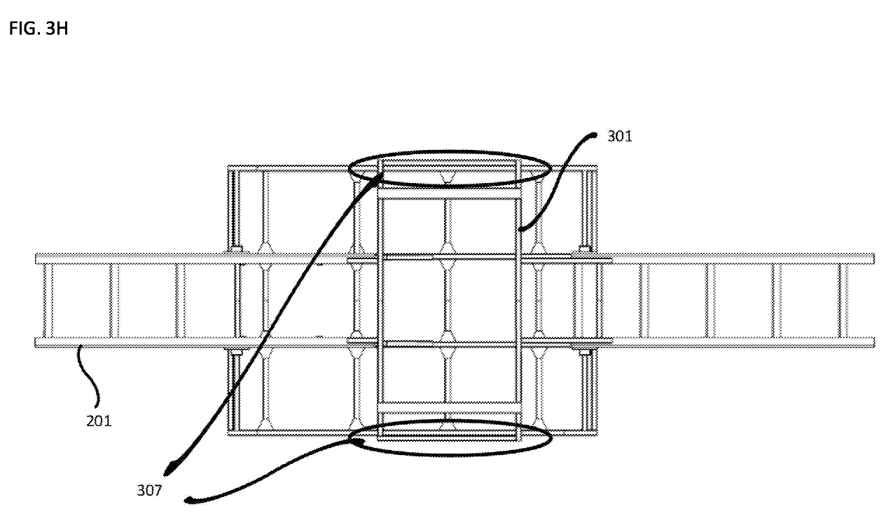

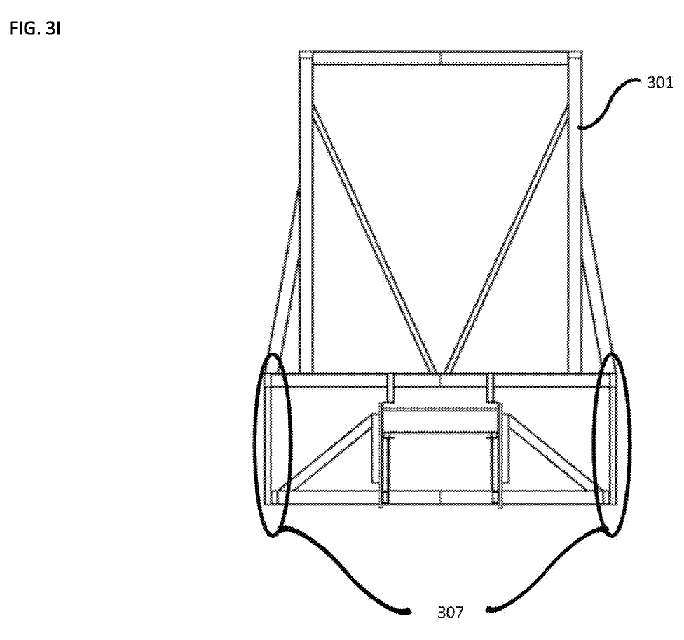

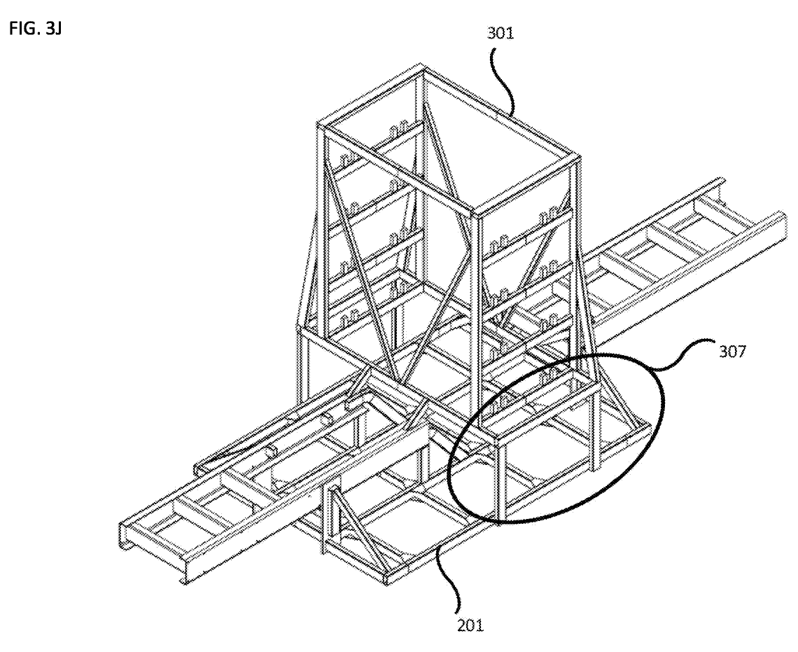

In some embodiments, as shown in FIG. 2C, the width 249 of the receptacle 201 is greater than the width between the front support elements 213-1 and 213-2; and rear support elements 215-1 and 215-2, denoted as 251 in FIG. 2C. This enables the receptacle 201 to accommodate a hydrogen storage frame 301 as shown in FIGS. 3A – 3C. The hydrogen storage frame 301 is coupled to top 205 of receptacle 201 at the rear of the cab, that is, in a backpack configuration.

Then, in some embodiments, hydrogen tanks are stored in a backpack configuration within hydrogen storage frame 301 as shown in FIG. 3A. As explained before, this results in a lower centre of gravity and rolling moment when compared to the backpack configurations showed in prior art systems.

Furthermore, as explained previously, coupling the storage frame with hydrogen tank systems to the relatively narrow chassis rails as disclosed in the prior art requires a heavy steel structure. By using a receptacle with a width greater than the width between the front support elements, the lighter space-frame chassis as discussed above can be used.

As previously explained with reference to FIGS. 1A-1D, and shown below in FIGS. 3A and 3C, attachment structure 305 is used to couple hydrogen storage frame 301 to receptacle 201 by attaching hydrogen storage frame 301 to receptacle 201. he design shown in FIGS. 3A-3C have a further advantage. By utilizing a truss-like shape, any member under compressive loading has multiple pathways to dissipate the load. Then, steel tubes with reduced thickness can be used, resulting in a weight reduction. n some embodiments, an attachment structure such as attachment structure 305 is not used. Example embodiments are shown in FIGS. 3D, 3E and 3F. Then, hydrogen storage frame 301 is coupled directly to top 205 of receptacle 201 as shown in FIGS. 3D, 3E and 3F. As explained previously, this configuration is used when, for example, the truck uses e-axles instead of a central motor. This enables hydrogen storage frame 301 to be coupled directly to top 205. This configuration leads to a lowered centre of gravity, which improves overall stability. This configuration also results in lowered overall weight. n yet other embodiments, an attachment structure similar to attachment structure 104 as shown in FIG. 1D is used to couple hydrogen storage frame 301 to receptacle 201 by attaching hydrogen storage frame 301 to receptacle 201. Example embodiments are shown in IGS. 3G, 3H, 3I and 3J. In these figures, attachment structure 307 is similar to attachment structure 104.

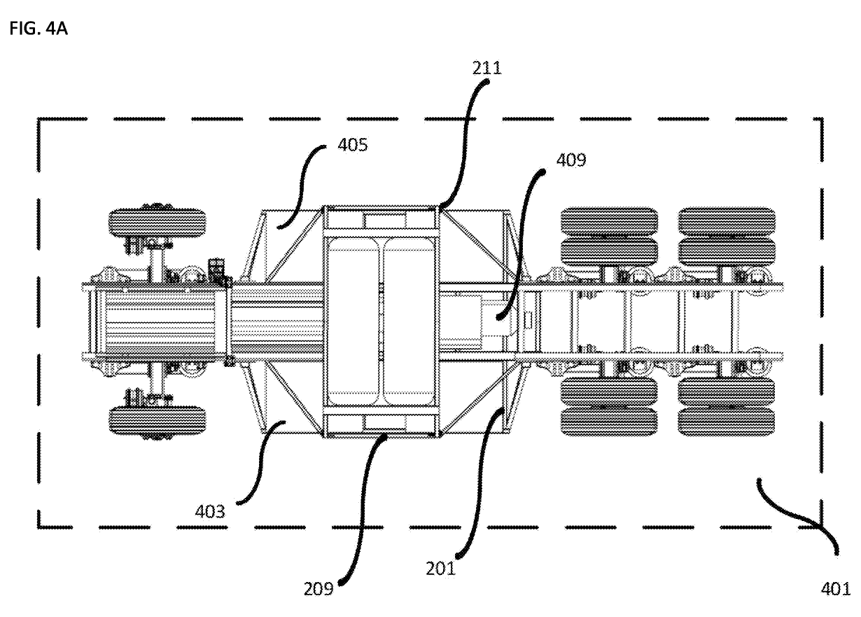

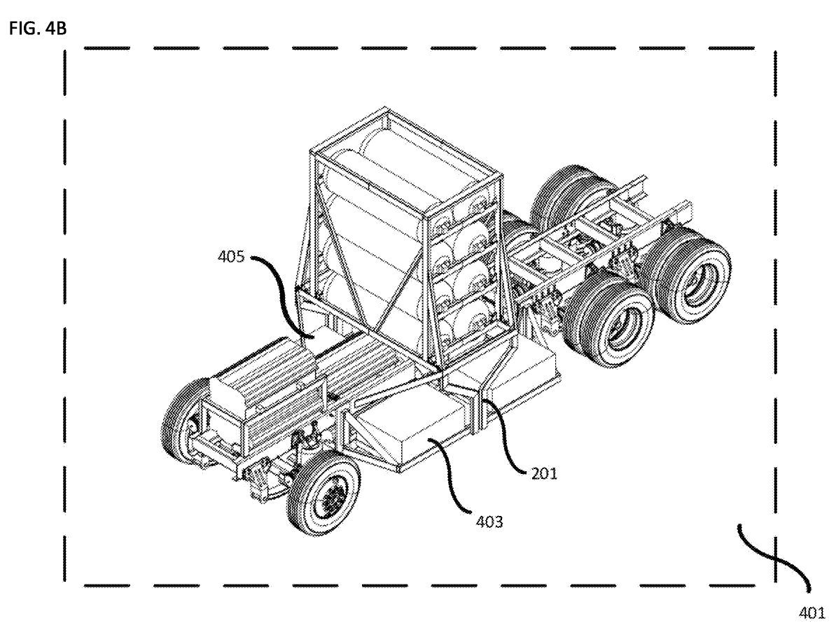

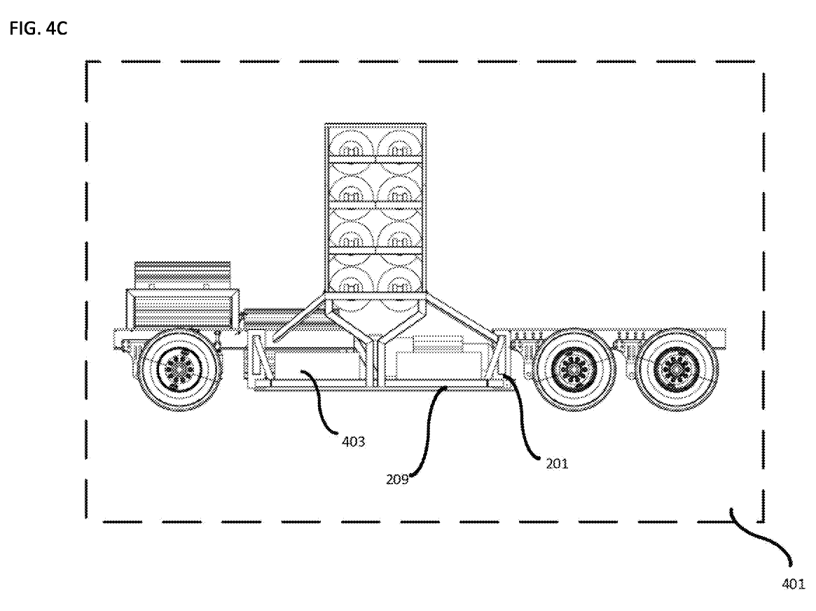

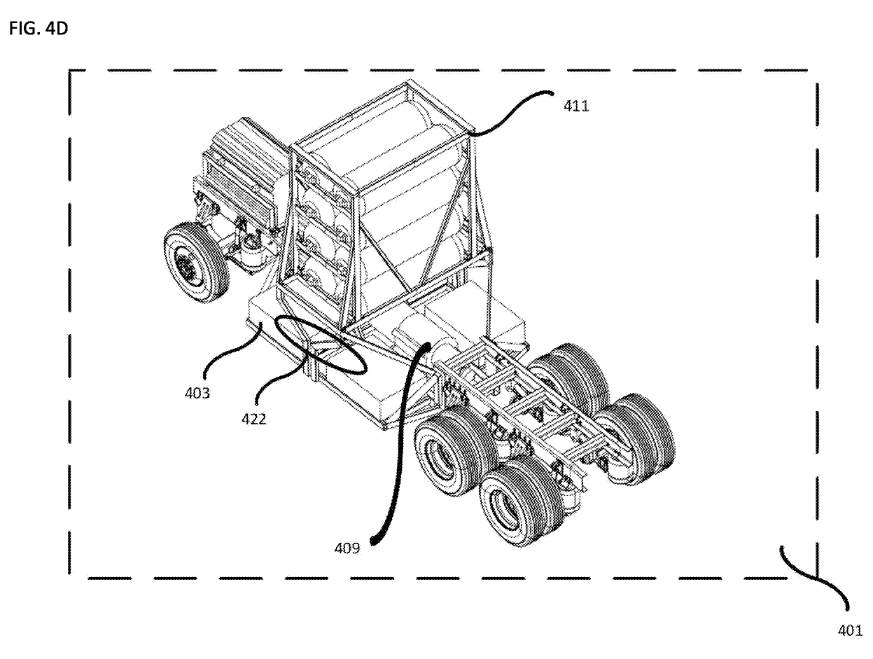

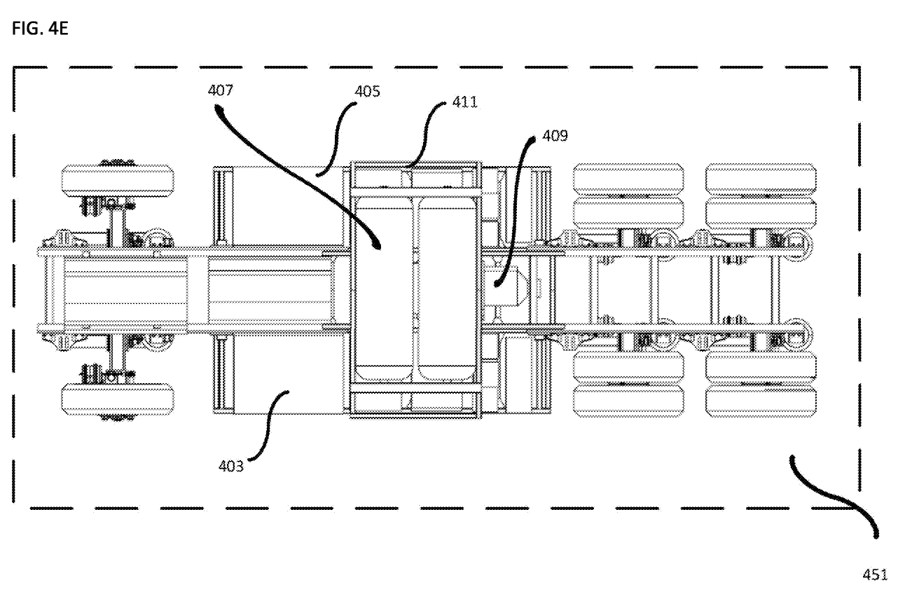

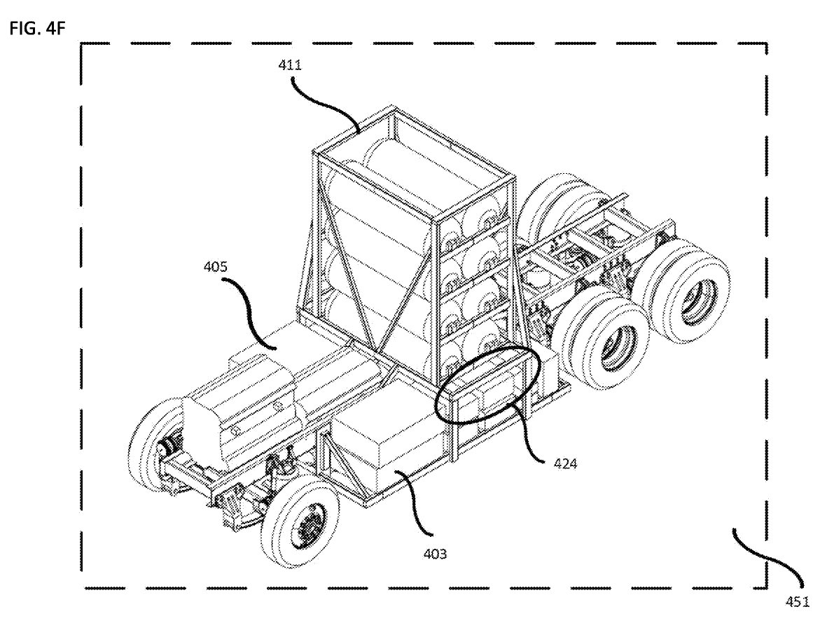

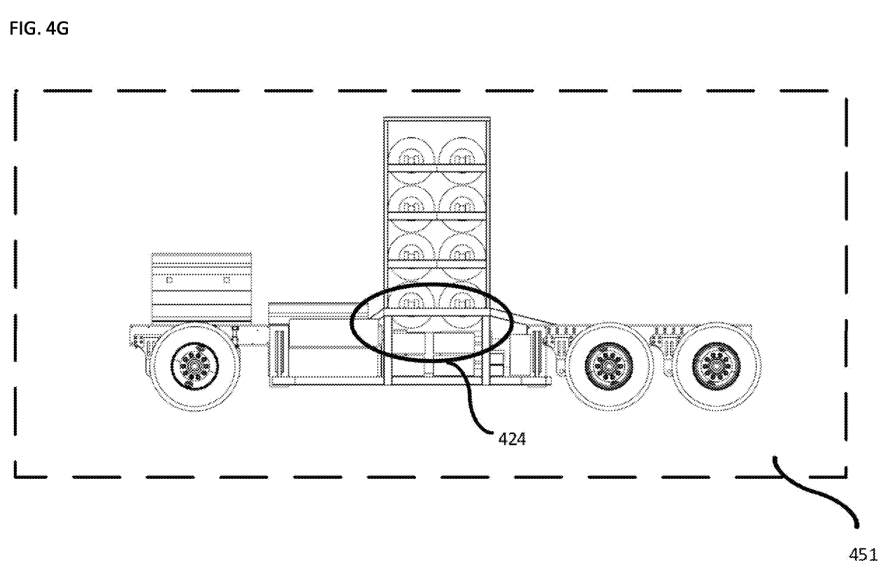

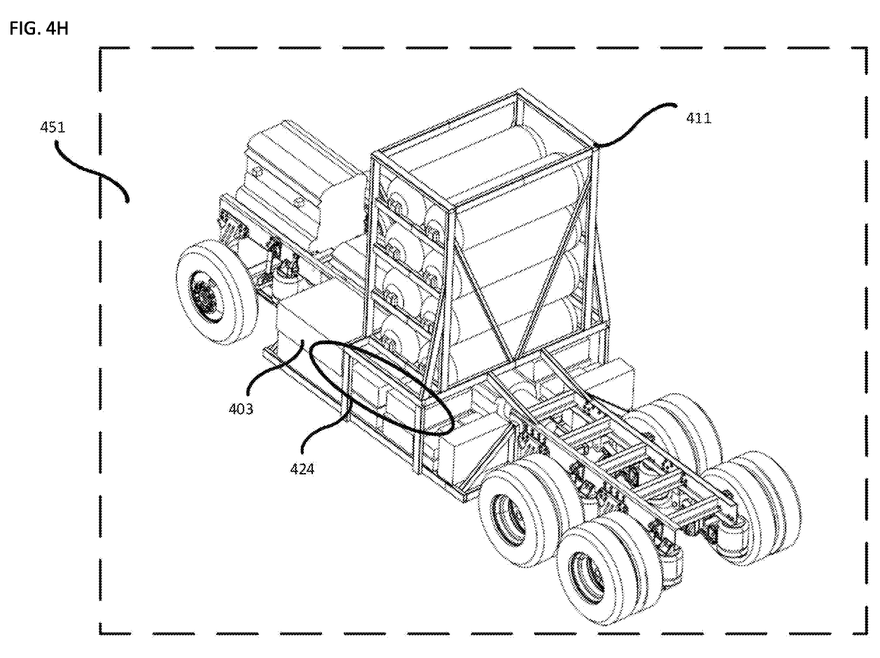

Various arrangements can be used to store the plurality of components in receptacle 201. FIGS. 4A-4D shows one embodiment of a storage arrangement or configuration 401, whereby:

- Fuel cell module 403 is stored adjacent to sidewall 209, One or more battery modules 405 are stored adjacent to sidewall 211, Drivetrain 409 is positioned between modules 403 and 405, and Hydrogen storage frame 411 is installed and hydrogen storage tanks 407 are stored in hydrogen storage frame 411.

In the embodiments shown in FIGS. 4A – 4D, attachment structure 422 is used to couple hydrogen storage frame 411 to the receptacle 201. Attachment structure 422 is similar to previously shown attachment structure 102 in FIGS. 1A and 1C. Other example embodiments are shown in FIGS. 4E-4H, which shows another embodiment of a storage arrangement or configuration 451. In FIGS. 4E-4H, attachment structure 424 which is similar to attachment structure 104 of FIG. 1D is shown.

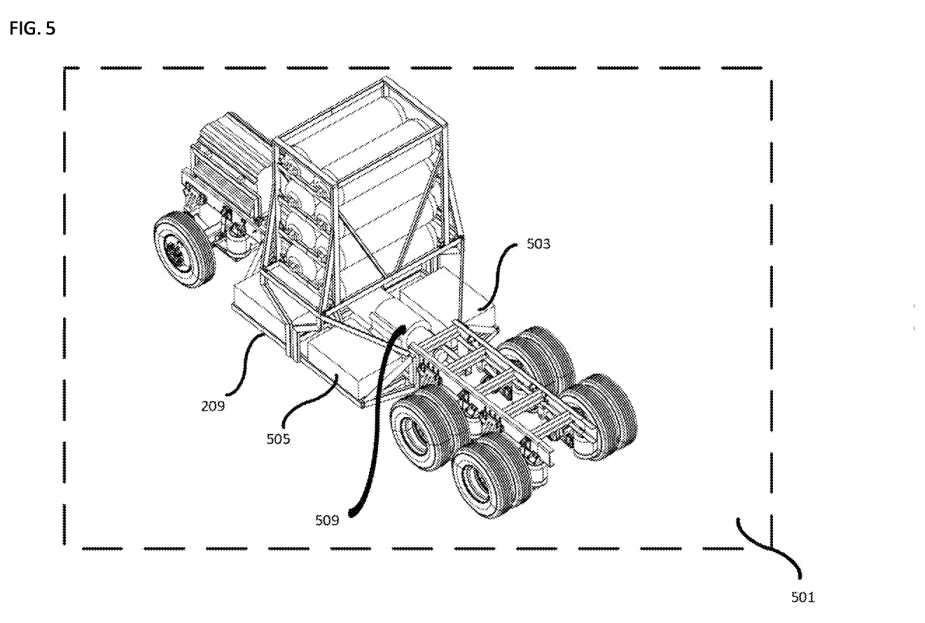

FIG. 5 shows another embodiment of a storage arrangement or configuration 501. In configuration 501,

One or more battery modules 505 is stored adjacent to sidewall 209,

Fuel cell module 503 is stored adjacent to the other sidewall 211, and

Drivetrain 509 is positioned between modules 503 and 505.

While the embodiments above in FIGS. 4A-4H and FIG. 5 all include a hydrogen storage frame, one of skill in the art would understand that there are embodiments where a hydrogen storage frame is not used.

As previously stated, one of ordinary skill in the art would understand that the space-frame chassis demonstrated above could also be used in, for example, an electric truck with batteries and no hydrogen fuel cells or fuel cell modules.

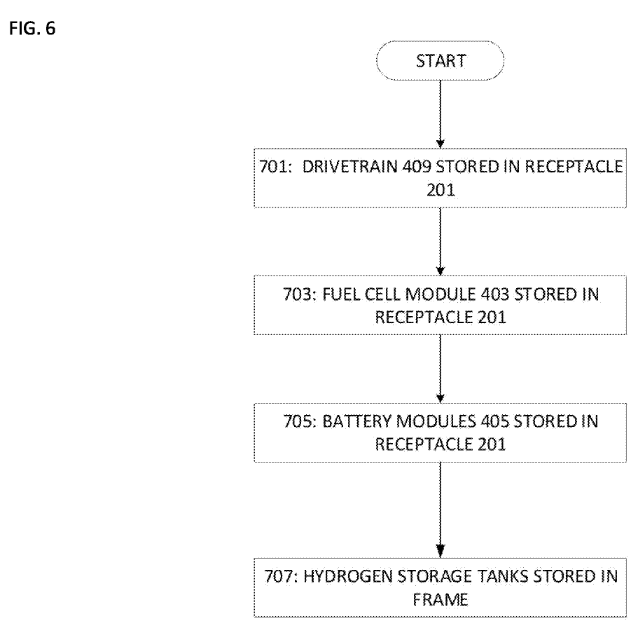

FIG. 6 shows a flowchart of an example process for storing the plurality of components with respect to configuration 401.

In step 701 drivetrain 409 is stored in receptacle 201.

In step 703 fuel cell module 403 is stored in receptacle 201 adjacent to sidewall 209.

In step 705, battery modules 405 are stored in receptacle 201 adjacent to sidewall 211.

In step 707, hydrogen storage frame 411 is attached to the receptacle and hydrogen storage tanks 407 are stored in hydrogen storage frame 411.

.As one of skill in the art would understand, similar processes are performed to achieve the configuration 501 in FIG. 5.

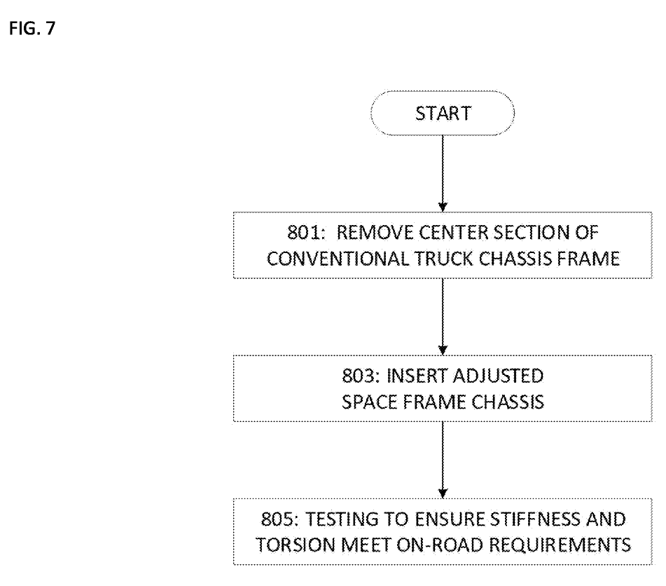

In some embodiments, the spaceframe chassis is created by modifying a conventional or typical truck chassis frame. An example embodiment of a process flow for modification is shown in FIG. 7.

In step 801, a center section in between a first section of conventional or typical truck chassis rails attached to the front suspension, and a second section attached to the rear suspension is removed. In some embodiments, this comprises detaching the center section from the first section and the second section by, for example, cutting.

In step 803, an adjusted spaceframe chassis based on spaceframe chassis 101 is inserted in between the above-mentioned sections of the conventional chassis rails attached to the front and rear suspensions. In some embodiments, the adjusted spaceframe chassis is, for example, spaceframe chassis 101 wherein one or more of:

In some embodiments, step 803 comprises coupling the adjusted spaceframe chassis to the first section and the second section using, for example, one or more of attachment members and mechanical coupling arrangements used specifically for modification. With regard to the process flow for modification, an example of an attachment member used specifically for modification is a bolt, and an example of a mechanical coupling arrangement used specifically for modification is a weld. - front support elements 213-1 and 213-2, and rear support elements 215-1 and 215-2; re shortened.

In some embodiments, a combination of attachment members and mechanical coupling arrangements specific to modification is used. In some of these embodiments, the combination is designed to ensure that the stiffness and torsion of the modified conventional chassis meets at least one requirement for on-road operation. In some embodiments, this comprises ensuring that the stiffness and torsion meet at least one threshold. In some embodiments, ensuring that the stiffness and torsion of the modified conventional chassis meets at least one requirement for on-road operation comprises restoring the stiffness and torsion of the modified conventional chassis to the stiffness and torsion of the conventional chassis prior to modification.

In some embodiments, designing the combination to achieve the stiffness and torsion required comprise, for example, performing one or more of: - at least one calculation, and - at least one simulation.

In step 805, testing to ensure that the stiffness and torsion meets the at least one requirement is performed.

One of skill in the art would understand that the embodiment shown in FIG. 7 is one example embodiment and variations of this embodiment are possible.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A space-frame chassis for a hydrogen fuel cell truck, wherein:
the truck comprises:
a cab,
a front suspension,
a rear suspension,
a front set of axles, and
a rear set of axles;
the space-frame chassis is coupled to the front set of axles and the rear set of axles, and supports the cab; and
the space-frame chassis comprises:
a receptacle to store a plurality of components, and
a plurality of front support elements and a plurality of rear support elements mechanically coupled to the receptacle, wherein:
the plurality of front support elements is coupled to the front suspension, and
the plurality of rear support elements is coupled to the rear suspension.

2. The space-frame chassis of claim 1, wherein the space-frame chassis is constructed using welded metal tubing.

3. The space-frame chassis of claim 1, wherein the plurality of components comprises a hydrogen storage unit.

4. The space-frame chassis of claim 1, wherein the plurality of components comprises one or more battery modules.

5. The space-frame chassis of claim 1, wherein a hydrogen storage frame is coupled to the receptacle.

6. The space-frame chassis of claim 5, wherein:
the hydrogen storage frame is attached to the receptacle using an attachment structure.

7. The space-frame chassis of claim 5, wherein: the hydrogen storage frame is directly coupled to the receptacle.

8. The space-frame chassis of claim 3, wherein the hydrogen storage frame is constructed utilizing a truss-like shape.

9. The space-frame chassis of claim 1, wherein the space-frame chassis is created based on a conventional chassis.

10. The space-frame chassis of claim 9, wherein the creating of the space-frame chassis comprises removing a center section of the conventional chassis.

11. A method for configuring storage of a hydrogen fuel-cell truck, wherein:
the truck comprises
a cab, and
a front set of axles and a rear set of axles, wherein:
a space-frame chassis is coupled to the front set of axles and the rear set of axles, and supports the cab, further wherein the space-frame chassis comprises:
a receptacle,
a front support element and a rear support element mechanically coupled to the receptacle, wherein:
the front support element is coupled to a front suspension, and
the rear support element is coupled to a rear suspension; and
the method comprises one or more of:
storing, using the receptacle, a plurality of components in an arrangement; or
attaching a hydrogen storage frame to the receptacle.

12. The method of claim 11, wherein the method comprises:
the attaching of the hydrogen storage frame to the receptacle; and
storing, using the attached hydrogen storage frame, at least one hydrogen tank.

13. A method of modifying a conventional chassis frame to create a first space frame chassis, wherein the conventional chassis frame comprises:
a first section attached to a front suspension,
a second section attached to a rear suspension, and
a center section located between the first section and the second section;
the method comprising:
removing the center section; and
inserting an adjusted space frame-chassis between the first section and the second section.

14. The method of claim 13, wherein:
the inserting comprises coupling the adjusted spaceframe chassis to the first section and the second section using one or more of:
one or more attachment members, and
one or more mechanical coupling arrangements.

15. The method of claim 14, wherein the one or more attachment members comprise a bolt.

16. The method of claim 14, wherein the one or more mechanical coupling arrangements comprise a weld.

17. The method of claim 14, wherein the coupling is performed using a combination of attachment members and mechanical coupling arrangements.

18. The method of claim 17, comprising designing the combination to ensure that stiffness and torsion of the modified conventional chassis meet at least one requirement for on-road operation.

19. The method of claim 18, wherein the designing comprises restoring the stiffness and the torsion of the modified conventional chassis to stiffness and torsion of the conventional chassis prior to modification.

20. The method of claim 13, wherein the adjusted spaceframe chassis is created by:
shortening one or more of:
front support elements; and
rear support elements
of a second space frame chassis.
